(19) United States
(12) Patent Application Publication
(10) Pub. No.: US 2024/0343060 A1
(43) Pub. Date: Oct. 17, 2024

(54) METHOD FOR FORMING A DECORATIVE SUBSTRATE FOR DECORATIVE PANEL, AND A METHOD FOR FORMING A DECORATIVE PANEL

(71) Applicants: Unilin, BV, Wielsbeke (BE); Interprint GmbH, Arnsberg (DE)

(72) Inventors: Benjamin CLEMENT, Wielsbeke (BE); Beauregard BOUTMANS, Wielsbeke (BE); Robert DAVID, Soest (DE); Malte TADDAY, Arnsberg (DE)

(73) Assignees: Unilin, BV, Wielsbeke (BE); Interprint GmbH, Arnsberg (DE)

(21) Appl. No.: 18/637,637

(22) Filed: Apr. 17, 2024

Related U.S. Application Data
(60) Provisional application No. 63/496,422, filed on Apr. 17, 2023.

(51) Int. Cl. B44C 5/04; B41M 3/12; B44F 9/02; B44F 9/04

(52) U.S. Cl. CPC B44C 5/04; B41M 3/12; B44F 9/02; B44F 9/04; B41M 2205/16

(57) ABSTRACT

A method for manufacturing a decorative substrate for decorative panels may involve providing a master image. The master image may be printed on a first printable substrate using an inkjet printer, thereby obtaining a first decorative substrate. A printing defect may be evaluated in the first decorative substrate. An error correction operation may be performed on the master image on the basis of the evaluation. A corrected master image may be printed on a second printable substrate to obtain a second decorative substrate. The error correction operation may involve adding an intentional defect to the corrected master image.

This application claims priority under 35 USC 119 (e) from U.S. Provisional Patent Application No. 63/496,422 filed Apr. 17, 2023, the entire contents of which are incorporated herein by reference.

### BACKGROUND

### 1. Field

The present invention relates to a method for manufacturing a decorative substrate, preferably a printed paper sheet or a printed thermoplastic foil, to be used in the manufacturing of decorative panels, preferably floor, wall or furniture panels. The invention may further relate to a method for manufacturing a decorative panel.

### 2. Discussion of Related Art

Paper sheets or plastic foils are usually printed using gravure printing for forming decorative substrates for decorative panels. In recent years the demand of decorative substrates being printed using digital inkjet printing, instead of analog printing, is increased because of the higher flexibility and higher variation of décor that inkjet printing can guarantee over gravure printing. As known to the skilled person, inkjet printing is performed by jetting droplets of inks through tiny nozzles in printheads of the printer. Every printhead can comprise hundreds or thousands of nozzles and every printer can comprise dozens of printheads. Said nozzles are susceptible to clogging and or to resonance depending on the printing condition thereby causing printing defects, like for example missing printing nozzles or banding defects.

WO 2020/104912 provides a method for solving missing nozzle or banding defect by modifying the dimension of printed dots.

Decorative panels usually have a décor imitating a wood, stone, ceramic and/or cement décor. During private research the inventors have noticed that since these kinds of décors are characterized by a substantially uniform base color, like for example, brown in case of wood or grey in case of stone and cement, they are also more prone to certain printing defects, especially banding, where any variation of the printing performances is highlighted by said uniform base color.

### SUMMARY

The present invention aims in the first place to provide an alternative method for manufacturing a decorative substrate for decorative panels, which, in accordance with several of its preferred embodiments, is directed to solve one or more of the problems arising in the state of the art.

Thereto the invention, in accordance with its first independent aspect, relates to a method for manufacturing a decorative substrate for decorative panels that comprises the steps of:
a) providing a master image;
b) printing said master image on a first printable substrate using an inkjet printer, thereby obtaining a first decorative substrate;
c) evaluating a printing defect in the first decorative substrate;
d) performing an error correction operation on said master image on the basis of said evaluation;
e) printing the corrected master image on a second printable substrate to obtain a second decorative substrate.

The method of the first independent aspect has the characteristic that said error correction operation at least involves adding an intentional defect to the corrected master image. Inventors have surprisingly found that adding said intentional defects can lead to forming a visual noise that can hide other kind of printing errors. In particular, the inventors have found that these intentional defects can work in combination with software for the correction of printing defects thereby improving the efficacy of said software. These kinds of software are normally directed to analyze the printing error and intervene on the master image and or on the printer in order to remove the cause of the printing defect itself. Nevertheless, during private research, inventors have found that said software may not be always sufficiently effective to obtain the desired quality required in decorative panels. Moreover, in certain cases, the software may correct the defects only temporarily so that during a production batch it may be necessary to intervene with the software more than once. On the other hand, adding the intentional defects, or noise, may lead to a more efficient disguising of other printing defects in a permanent way as they are independent from the cause of the printing defects.

The intentional defects can be included in the corrected master image so that they depend on the master image itself and not on the printing condition thereby disguising other printing defects permanently in a production batch.

The printing defect in step c) can be selected from the group comprising, preferably consisting, of: missing nozzle, banding defects, deflected nozzles, printhead stitch issues. During private research, the inventors have found that the addition of intentional defects in the master image is particularly efficient in disguising these kinds of defect. For example, an apparently imperceptible variation of the color tonality in a certain point, for example in a certain pixel, of the printed décor can hide a near missing printed pixel caused by a missing printing nozzle Similarly, a substantially or apparently random distribution of pixel with different color tonality from the color tonality of the surrounding pixels can make the printed image less flat and hide a banding defect.

The correction in step d) can further comprise one or more of the following operations: modifying drop sizes at predetermined spots and/or modifying the number of droplets at predetermined spots. These corrections can be performed using dedicated software like Meteor Metcal or GIS. These corrections can provide for a good and at least temporary, remedy to printing defects, and can be further improved by adding the additional defects as explained above.

In a preferred embodiment, said intentional defect comprises additional droplets of inks of a first color tone jetted in an area of the printed décor having a predominant second color tone. For example, said intentional defect can comprise a pixel or a group of pixels having the first color tone being surrounded by pixels having the second color tone. In case of group of pixels it is preferred that said group is formed by less than 5 pixel, more preferably less than 3 pixels. In this way the defect is sufficiently small to be apparently imperceptible so that can contribute to the disguising of other defects without affecting the quality of the print.

Preferably said area of the second color tone can be adjacent to an area having predominant first color tone. For example, the said additional droplets are present in the 20, preferably 10 pixels, adjacent to said area having the first color tone. In this way said additional droplets can be less evident and perceptible as they are disposed around an area of the décor having the same, or similar color tone. For example, said area having predominant first color tone can be formed by a group of pixels comprising at least 20 pixels, preferably at least 50 pixels. In some embodiments, said area of the second color tone is an unprinted area.

Preferably, the droplets may have a dimension below 7 pl, more preferable below 5 pl, even more preferable below 3.5 pl. In this way the defect is sufficiently small to be apparently imperceptible so that can contribute to the disguising of other defects without affecting the quality of the print.

In some embodiments, said additional droplets have an optical density (M0) below 5%, or on optical density (M0) below 0.2 In this way the defects are less visible to the human eye so that their effect on the quality of the printed décor is limited.

Said additional droplets may substantially correspond to pixels of the corrected master image which are not present in the first master image.

Said intentional defects can be generated by a software running on a computer. Said software can be configured to analyze the master image and create the intentional defect on the basis of said analysis.

In the preferred embodiment, said first master image represents a uniform color, or a cement décor, a stone décor or a wood décor. Said décors have the characteristic of showing a predominant color, and in this condition the printing operation is more prone to develop certain printing defects like, in particular, banding or missing printing nozzles. Therefore, the inventors have found that it is in particular with this kind of décors that the invention is more effective.

In the preferred embodiments, the printing substrate can be a paper sheet or a thermoplastic foil. In some special embodiment, the printing substrate can be a rigid material like for example a board for forming the base of the decorative panel. This is particularly the case when the board is made of a plastic material, preferably thermoplastic, for example PVC (polyvinylchloride) or PP (polypropylene), or thermosetting material, as well as mineral boards or cement-based board. In any of the above-mentioned cases, the printing substrate can comprise an ink receiver layer on at least one of its surfaces.

In some embodiments the printing substrate may be a colored, for example pigmented and/or dyed base. It is noted that the inventors have found that using a colored printing substrate can reduce the risk of forming the banding defect. In particular, the color of the printing substrate can be selected to be the same or similar to the predominant color of the décor so that the décor itself is provided on a uniformly colored background and the and banding defect, or missing printing nozzle, are less evident. Alternatively, it is also possible that an ink receiver substance on the surface of the printable substrate is colored.

In case the printing substrate is a paper sheet, it is preferably made of a paper of the type suitable for being impregnated with a thermosetting resin. Preferably said paper sheet comprises a base paper weight, i.e. without ink receiving layer, higher than 20 grams per square meter, preferably between 50 to 100 grams per square meter, e.g. between 60 and 80 grams per square meter. Preferably, the paper sheet in case it comprises an ink receiver layer shows a resin penetration time lower than 3 sec. The paper sheet can show a mean air resistance as expressed in Gurley value below 40 sec, preferably below 25 sec. Paper showings said mean air resistance are more prone to impregnation with resins. Preferably, the paper sheet can be opaque and/or contains titanium oxide as a whitening agent and/or other inorganic fillers.

In case the printing substrate is a thermoplastic foil it can be made of, for example, vinyl-based plastics, polyolefins, or polyesters, preferably selected from the group consisting of: polyvinyl chloride (PVC), polyethylene (PE) and polypropylene (PP), polyurethane (PU), polystyrene (PS), acrylonitrile-butadiene-styrene (ABS), polymethyl methacrylate (PMMA), polycarbonate (PC), polyethylene terephthalate (PET), PETG, or mixtures or co-polymers thereof.

The ink receiver coating can comprise a binder a flocculant and optionally a pigment. The ink receiver coating can be on the base printing substrate in an amount up to 5 g/sqm dry weight (grams per square meter).

In some embodiments, and in particular in case the printing substrate is made on plastic or mineral material, said binder can preferably comprise a water-based dispersion of terpolymer vinyl chloride and vinyl acetate ethylene;a water-based dispersion of vinyl chloride-vinyl acetate; a water-based aliphatic PU dispersion; other non-blocking water-based acrylics dispersions. Alternatively, in case said printing substrate is made of paper, the binder is mainly composed of polyvinyl alcohol. The binder can form from the 20 to the 90% of the dry weight of the ink receiver coating.

The flocculant is preferably a metal salt. The metal salt can comprise a cationic metal salt, for example CaCl2. The flocculant can form from the 10 to the 80% of the dry weight of the ink receiver coating.

Although not essential, in some embodiments, the ink receiver coating can comprise a pigment, preferably in form of inorganic pigment, especially silica particles. The pigment can form from the 10 to the 80% of the dry weight of the ink receiver coating.

The inkjet receiving layer can further comprise a cross linker and/or other additives like dispersant, coupling agent, wetting agent or PH modifiers.

The ink can be a water-based ink, a solvent-based ink, or a UV curable ink. In the preferred embodiments, the ink is water-based especially when the substrate is made of paper, whereas can be UV curable especially when the substrate is made of plastic or mineral. The ink preferably comprises a colorant element in the form of a pigment.

It is noted that the first printable substrate and the second printable substrate can have one or more characteristics in common. It is also possible that the first and the second substrate are substantially identical.

Preferably, the printing operation is performed using an inkjet printer of the single pass type or of the multi-pass type. In some embodiments, the first printable substrate can be printed with a first printing equipment and the second printable substrate can be printed using a different printing equipment. This is especially the case when the first printing equipment is a sampling printer, preferably a multi-pass or a plotter, and the second printer is a production printer, for example a single pass printer or a multi-pass printer. The obtained second decorative sheet can be used in manufacturing of decorative panels having a support layer and top layer, said top layer comprising the decorative sheet and, optionally, a wear layer.

According to a special embodiment, the first and the second substrate as well as the first and the second printer can coincide. In this special embodiment, the image correction can be performed contemporarily to the printing operation so that when a defect is detected it can be immediately corrected.

It is noted that the addition of the intentional defect in the master image can be performed independently from the evaluation of the error with the aim of preventing the error itself. Thereto, according to its second independent aspect, the invention may relate to a method for manufacturing a decorative substrate for decorative panels that comprises the steps of:
a′) providing a master image;
b′) performing an image processing operation on said master image to obtain a modified master image;
e) printing the modified master image on a printable substrate to obtain the decorative substrate.

The method of the second independent aspect has the characteristic that said image processing operation at least involves adding an intentional defect to the modified master image.

It is noted that the method of said second independent aspect, in particular of said intentional defects, of the master image and of the printable substrate, can show one or more of the characteristics already described in relation to the first independent aspect.

It is noted that the invention further relates to a method of manufacturing a panel using the decorative substrate obtained or obtainable from the method according to the first and/or the second independent aspect.

The method of manufacturing a panel comprises one or more steps which substantially depend on the kind of decorative substrate.

In case the decorative substrate is in form of a paper sheet, it is preferable that said paper is impregnated with a thermosetting resin, preferably melamine-based resin, and is fixed on the support layer via heat and pressure, for example in a short cycle press. In this is case it is preferable that the wear layer is in form of an overlay paper sheet is impregnated with a thermosetting resin and that it is fixed on to the decorative substrate via heat and pressure.

In case the decorative substrate is in the form of a plastic foil, it is preferable that said foil is fixed on the support layer via gluing and or via thermal lamination. In this is case it is preferable that the wear layer is a transparent plastic sheet and fixed to the decorative substrate via thermal lamination or gluing.

In case the decorative substrate is in the form of a rigid board, being it plastic or mineral, the method of manufacturing the panel can comprise providing a wear layer above the printed décor, thereby obtaining a panel wherein the decorative substrate is also the support of the panel. The wear layer can be in form of a transparent plastic sheet and fixed to the decorative substrate via thermal lamination or gluing. Alternatively, the wear layer can be in form of one or more coating layer which may be provided, for example poured, in form of a radiation curable substance and then cured, for example via UV or EB.

It is noted that, in some special embodiments, the first printable substrate and the second printable substrate can be in form of a board and the printing operations can be performed directly on the board.

### BRIEF DESCRIPTION OF THE DRAWINGS

With the intention of better showing the characteristics of the invention, in the following, as an example without any limitative character, several preferred forms of embodiments are described with reference to the accompanying drawings, wherein:

FIG. 1 is a schematic view of some steps of the method according to a first independent aspect of the invention;

FIGS. 2 and 3 are enlarged view respectively of details F2 and F3 of FIG. 1;

FIG. 4 is a schematic view of some further steps of the method according to a first independent aspect and shows a perspective of a decorative panel;

FIG. 5 is a schematic view of some steps of the method according to a special embodiment of the first independent aspect; and

FIG. 6 is a schematic view of some steps of the method according to a second independent aspect of the invention.

### DESCRIPTION OF NON-LIMITING EMBODIMENTS

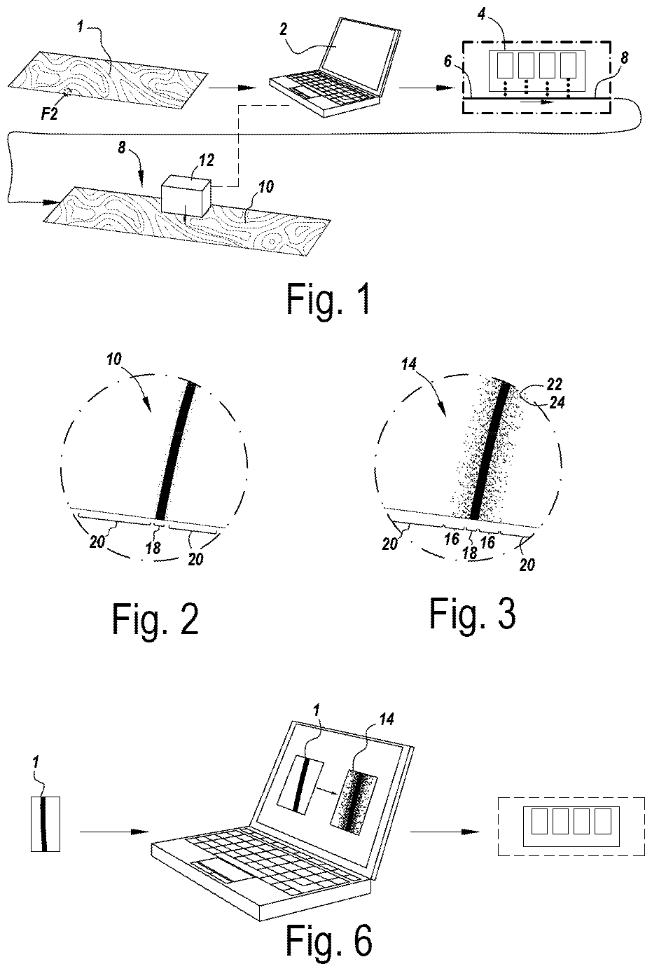

FIG. 1 shows some steps of a method according to a first aspect of the invention wherein a master image 1, for example illustrating a stone décor and having the characteristic of comprising a predominant grey color, is loaded in a memory of a computer 2 which is connected to a printer 4.

In the example, the printer 4 is a multi-pass inkjet printer configured for printing water-based inks on a first printable substrate 6. In this example the printable substrate is a paper for rotogravure printing having a weight higher than 20 grams per square meter, preferably between 50 to 100 grams per square meter, e.g. between 60 and 80 grams per square meter. The base paper sheet shows a mean air resistance as expressed in Gurley value below 40 sec, preferably below 25 sec. The printable substrate 6 further comprises an ink receiver layer.

The master image 1 is printed using the printer 4 on the first printable substrate 6 to obtain a first decorative substrate 8 having a first printed décor 10.

The first printed décor 10 is then scanned using a scanner 12 connected to the computer 2 for the evaluation of the printing quality and for the identification of printing errors like, especially, banding. On the basis of said evaluation the first master image 1 is subjected to an image processing operation, using a software running on the computer 2.

As a result of the image processing operation a modified master image 14 is obtained that comprises added intentional defects 16 as better shown in FIG. 3.

FIGS. 2 and 3 respectively show an enlarged view of the same portion of the first master image 1 and in the modified master image 14. The selected portion comprises a first area 18 having a predominant first color, for example black, and a second area 20, having a predominant second color, for example white. As visible in FIG. 2, the transition between the first and second area 18, 20 is well defined.

As visible in FIG. 3, the modified master image 14 comprises additional defects 16 in the form of first pixels or a group of firsts pixels 22 having the first color tone, for example black, present in the second area 20. Said firsts pixels 22 of the first color tone are surrounded by second pixels 24 having the second color tone, for example white.

As visible in FIG. 3, the first pixels 22 forming the intentional defects 16 are present in the second area 20, preferably 10 pixels, adjacent to said first area 18 having the first color tone.

The first pixels 22 have an optical density (M0) below 5%. Or below an optical density M0<0.2

The modified master image 14 is configured such that during printing the intentional defects 16 are printed in the form of droplets of ink that have a dimension below 7 pl, more preferable below 5 pl, even more preferable below 3.5 pl.

The modified master image 14 is then printed using a second printer 26, for example a single pass inkjet printer configured for printing water-based inks on a second printable substrate 28 to obtain a second decorative substrate 30. The second printable substrate 28 can be the same as the first printable substrate 6.

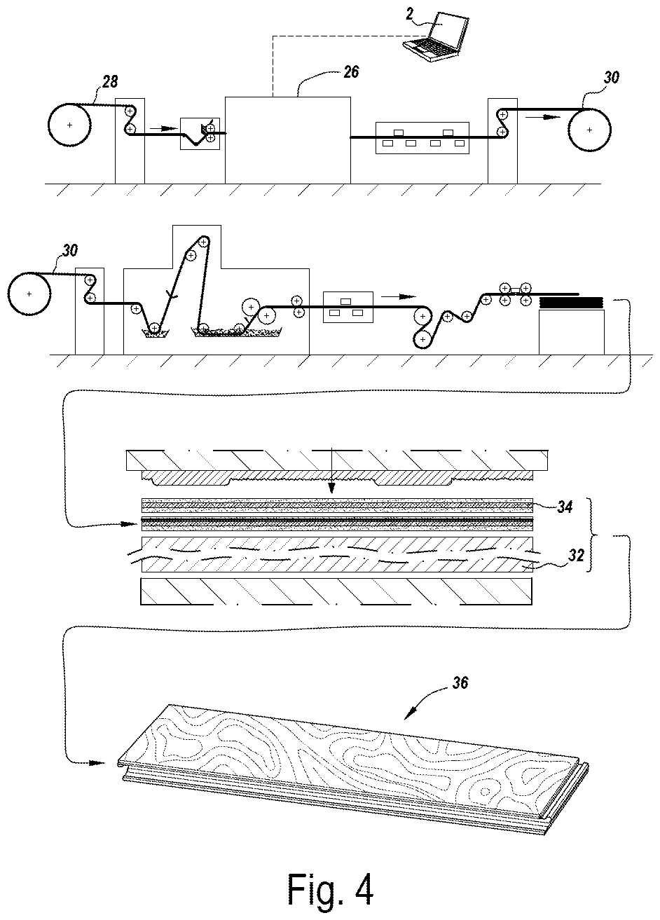

The second decorative substrate 30 is then impregnated with a melamine-based thermosetting resin, and is sandwiched between a wood-based board 32 and a melamine-based thermosetting resin impregnated overlay paper 34 to form a floor panel 36 shown in FIG. 4.

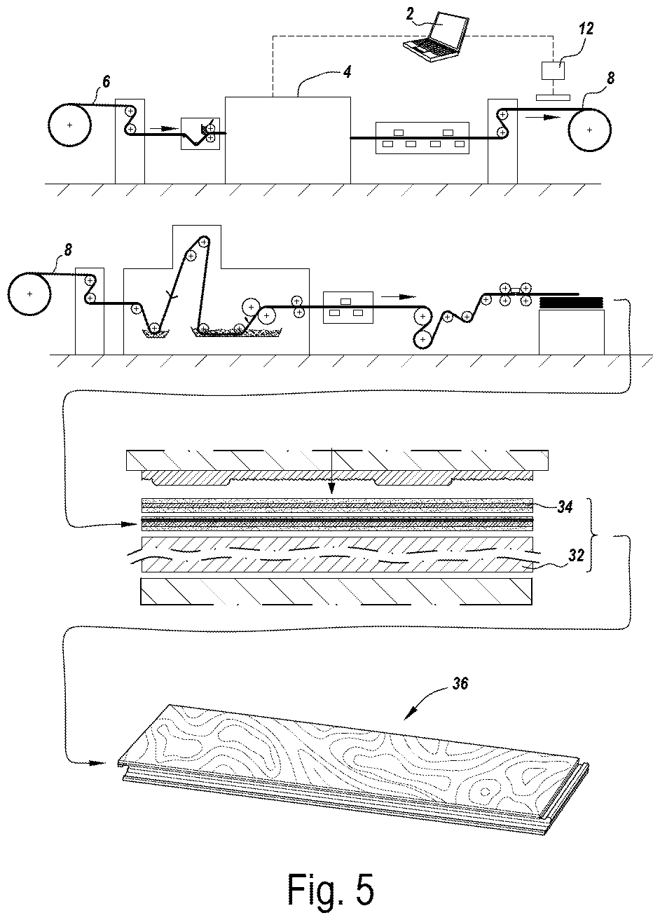

FIG. 5 shows a special embodiment of the invention wherein the first and the second substrate coincide, so that the correction is performed contemporarily to the printing operation. In this example the first printer 4 is a single pass printer which works in a roll-to-roll configuration, i.e. wherein the first printable substrate 6 is uncoiled from a roll, printed and then the obtained decorative substrate 8 is coiled in a second roll. In the illustrated example, the scanner 12 identifies and evaluates printing defects in the first decorative substrate 8 downstream of the first printer 4 which is connected to the computer 2 to add the intentional defect to the first master image during the same printer operation so that the resulting first decorative substrate 8 will have a portion with the defect, which can be discarded later on, and a second portion without the printing defect. The first decorative substrate 8, and in particular, the portion free from the defect, is subsequently impregnated and laminated on a substrate 32 as described in relation to FIG. 4.

FIG. 6 shows some steps of the method according to its second aspect. The method of this second aspect differs from the first substantially in that the image processing operation that leads from the first master image 1 to the modified master image 14 is performed directly without the necessity of printing the first master image 1 on the first printable substrate 6, and without the evaluation thereof.

The invention is further disclosed by the following item list as defined by the below numbered items.

1. A method for manufacturing a decorative substrate for decorative panels that comprises the steps of:
a) providing a master image;
b) printing said master image on a first printable substrate using an inkjet printer, thereby obtaining a first decorative substrate;
c) evaluating a printing defect in the first decorative substrate;
d) performing an error correction operation on said master image on the basis of said evaluation;
e) printing the corrected master image on a second printable substrate to obtain a second decorative substrate,
wherein the method has the characteristic that said error correction operation at least involves adding an intentional defect to the corrected master image.

2. The method according to item 1, wherein the printing defect in step c) can be selected from the group comprising, preferably consisting, of: missing nozzle, banding defects, deflected nozzles, printhead stitch issues.

3. The method according to any of the preceding items, wherein the corrections in step d) can further comprise one or more of the following operations: modifying drop sizes at predetermined spots and/or modifying the number of droplets at predetermined spots.

4. The method according to any of the preceding items, wherein the corrections in step d) can be performed using dedicated software like Meteor Metcal or GIS.

5. The method according to any of the preceding items, wherein said intentional defect comprises additional droplets of inks of a first color tone jetted in an area of the printed décor having a predominant second color tone.

6. The method according to item 5, wherein said intentional defect can comprise a pixel or a group of pixels having the first color tone being surrounded by pixels having the second color tone.

7. The method according to item 6, wherein said group is formed by less than 5 pixel, more preferably less than 3 pixels.

8. The method according to any of items from 5 to 7, wherein said area of the second color tone can be adjacent to an area having predominant first color tone.

9. The method according to item 8, wherein said additional droplets are present in the 20, preferably 10 pixels, adjacent to said area having the first color tone.

10. The method according to item 8 or 9, wherein said area having predominant first color tone can be formed by a group of pixels comprising at least 20 pixels, preferably at least 50 pixels.

11. The method according to any of items from 5 to 10, wherein said area of the second color tone is an unprinted area.

12. The method according to any of items from 5 to 11, wherein the droplets may have a dimension below 7 pl, more preferable below 5 pl, even more preferable below 3.5 pl.

13. The method according to any of items from 5 to 12, said additional droplets have an optical density below 5 or an optical density M0<0.2.

14. The method according to any of items from 5 to 13, wherein said additional droplets may substantially correspond to pixels of the corrected master image which are not present in the first master image.

15. The method according to any of the preceding items, wherein said intentional defects can be generated by a software running on a computer.

16. The method according to any of the preceding items, wherein said first master image represents a uniform color, or a cement décor, a stone décor or a wood décor.

17. The method according to any of the preceding items, wherein the printing substrate can be a paper sheet or a thermoplastic foil.

18. The method according to item 17, wherein the printing substrate is a paper sheet of the type suitable for being impregnated with a thermosetting resin.

19. The method according to any of the preceding items, wherein the printing substrate can be a rigid material like for example a board for forming the base of the decorative panel.

20. The method according to any of the preceding items, wherein the printing substrate may be a colored, for example pigmented and/or dyed base.

21. The method according to any of the preceding items, wherein the printing substrate can comprise an ink receiver layer on at least one of its surfaces.

22. The method according to item 21, wherein the ink receiver substance on the surface of the printable substrate is colored.

23. The method according to any of the preceding items, wherein the first printable substrate can be printed with a first printing equipment and the second printable substrate can be printed using a different printing equipment.

24. The method of any of the preceding items wherein the first printable substrate and the second printable substrate are the same substrate, and preferably are printed with the same printer.

25. A method for manufacturing a decorative substrate for decorative panels that comprises the steps of:
a′) providing a master image;
b′) performing an image processing operation on said master image to obtain a modified master image;
e) printing the modified master image on a printable substrate to obtain the decorative substrate;
wherein the method has the characteristic that said image processing operation at least involves adding an intentional defect to the modified master image.

26. A method of manufacturing a panel using the decorative substrate obtained or obtainable from the method according to any of the preceding items.

27. A method for manufacturing a decorative substrate for decorative panels that comprises the steps of:
a) providing a master image;
b) printing said master image on a first portion of a printable substrate using an inkjet printer, thereby obtaining a first decorative substrate;
c) evaluating a printing defect in the first decorative substrate;
d) performing an error correction operation on said master image on the basis of said evaluation;
e) printing the corrected master image on a second portion of the printable substrate to obtain a second decorative substrate,
wherein the method has the characteristic that said error correction operation at least involves adding an intentional defect to the corrected master image.

1. A method for manufacturing a decorative substrate for decorative panels, the method comprising:
a) providing a master image;
b) printing the master image on a first printable substrate using an inkjet printer, thereby obtaining a first decorative substrate;
c) evaluating a printing defect in the first decorative substrate;
d) performing an error correction operation on the master image on the basis of the evaluation to obtain a corrected master image;
e) printing the corrected master image on a second printable substrate to obtain a second decorative substrate;
wherein the error correction operation involves adding an intentional defect to the corrected master image.

2. The method according to claim 1, wherein the printing defect in step c) is selected from the group consisting of: a missing nozzle, banding defects, deflected nozzles, and printhead stitch issues.

3. The method according to claim 1, wherein the error correction operation in step d) involves one or more of: modifying drop sizes at predetermined spots and/or modifying a number of droplets at predetermined spots.

4. The method according to claim 1, wherein the error correction operation in step d) is performed using dedicated software.

5. The method according to claim 1, wherein the intentional defect comprises additional droplets of inks of a first color tone jetted in an area of a printed décor having a predominant second color tone.

6. The method according to claim 5, wherein the intentional defect comprises a pixel or a group of pixels having the first color tone being surrounded by pixels having the second color tone.

7. The method according to claim 6, wherein the group is formed by less than 5 pixels.

8. The method according to claim 5, wherein the area of the second color tone is adjacent to an area having a predominant first color tone.

9. The method according to claim 8, wherein the additional droplets are present in the area having the second color tone adjacent to the area having the first color tone.

10. The method according to claim 8, wherein the area having the predominant first color tone is formed by a group of pixels comprising at least 20 pixels.

11. The method according to claim 5, wherein the area of the second color tone is an unprinted area.

12. The method according to claim 5, wherein the additional droplets may have a dimension below 7 pl.

13. The method according to claim 5, wherein the additional droplets have an optical density (M0) below 5.

14. The method according to claim 5, wherein the additional droplets correspond to pixels of the corrected master image which are not present in the master image.

15. The method according to claim 1, wherein the intentional defect is generated by a software running on a computer.

16. The method according to claim 1, wherein the master image represents a uniform color, or a cement décor, a stone décor or a wood décor.

17. The method according to claim 1, wherein the first printable substrate and/or the second printable substrate is a paper sheet or a thermoplastic foil.

18. The method according to claim 17, wherein the first and/or the second printable substrate is a paper sheet of the type suitable for being impregnated with a thermosetting resin.

19. The method according to claim 1, wherein the first and/or the second printable substrate is a rigid material for forming a base of the decorative panel.

20. The method according to claim 1, wherein the first and/or the second printable substrate is a colored base.
